(19) United States
(12) Patent Application Publication
(10) Pub. No.: US 2004/0265499 A1
(43) Pub. Date: Dec. 30, 2004

(54) Method of forming patterns on articles

(75) Inventors: Kenichi Hashizume, Gunma (JP); Makoto Yoshimuru, Shizuoka (JP)

Correspondence Address: HARRINGTON & SMITH, LLP, 4 RESEARCH DRIVE, SHELTON, CT, 06484-6212, US

(73) Assignee: NOKIA CORPORATION

(21) Appl. No.: 10/606,381

(22) Filed: Jun. 24, 2003

(51) Int. Cl. B05D 3/04

(52) U.S. Cl. 427/437; 427/256; 427/301; 118/46

(57) ABSTRACT

A method of forming a pattern on an article comprising applying a carrier material to a substrate to provide the pattern, the carrier material carrying a seeding substance to allow application of a metallic material thereto, moulding the substrate to form the article, and applying the metallic material to the seeding substance on the carrier material.

This invention relates to methods of forming patterns on articles. The invention also relates to articles having patterns thereon. More particularly, but not exclusively, the invention relates to mobile phone housings having electrical connector patterns thereon, and to methods of forming electrical connector patterns on mobile phone housings.

In the mobile phone industry, the density of components in the housing is increasing, in view of the demand to make the products smaller. There are also demands to increase the functions of mobile phones, for example by providing them with a camera facility and for the capabilities for input devices.

In order to mitigate these problems, metallic line patterns have been formed on the housing of the mobile phone to accommodate the electronic components thereon. However, the formation of such line patterns economically and using mass producible methods has been difficult.

According to one aspect of this invention there is provided a method of forming a pattern on an article comprising applying a carrier material to a seeding substrate to provide the pattern, the carrier material carrying a substance to allow application of a metallic material thereto, moulding the substrate to form the article, and applying the metallic material to the seeding substance on the carrier material.

According to another aspect of this invention there is provided a moulded article comprising a substrate and a substrate and a pattern on the substrate, the pattern comprising a first layer of a carrier material, carrying a seeding substance, and a second layer of metallic material, the second layer providing electrical connections.

According to another aspect of this invention there is provided apparatus for forming a pattern on an article comprising a supply assembly for supplying a substrate, a first applicator for applying a carrier material to the substrate, the carrier material carrying a seeding substance to allow application of a metallic material thereto, a moulding arrangement for moulding the substrate to form the article, and a second applicator for applying the metallic material to the seeding substance on the carrier material.

An embodiment of the invention will now be described by way of example only, with reference to the accompanying drawings, in which:—

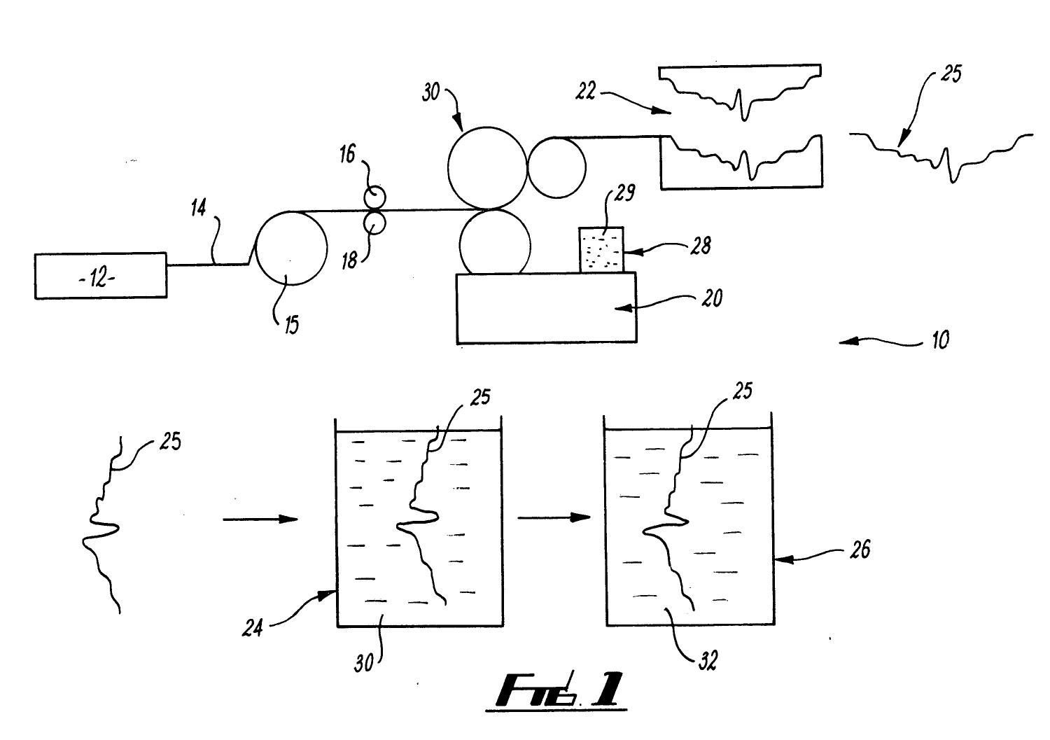

FIG. 1 shows an apparatus for use in a method of forming an article; and

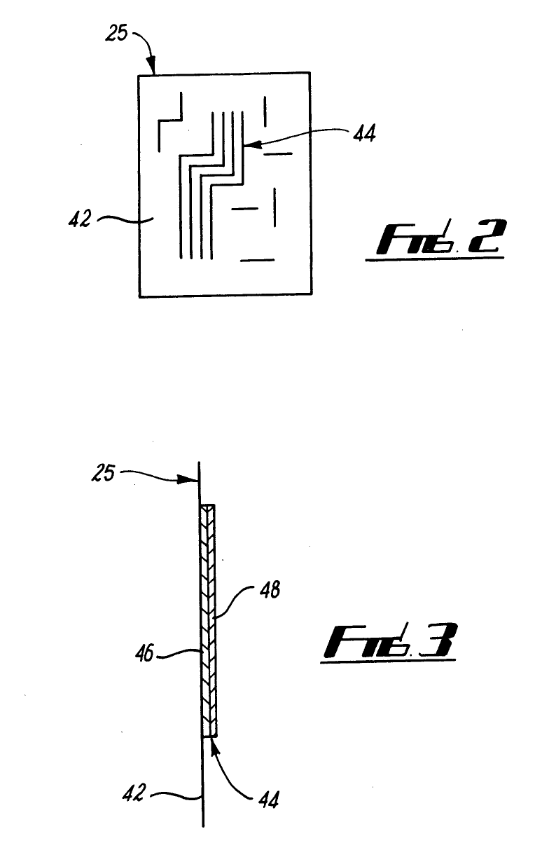

FIG. 2 is a diagrammatic view of an article formed by the apparatus shown in FIG. 1; and

FIG. 3 is a sectional side view of the article shown in FIG. 2.

Referring to FIG. 1, there is shown an apparatus 10 for forming an article, for example a housing 25 for a mobile phone, which is provided with an integral electrical circuit line pattern 44 (see FIGS. 2 and 3). The apparatus 10 comprises a supply of a plastic sheet 14, which is fed to a feed roller 15, a pair of pinch rollers 16, 18 through which the plastic sheet 14 is fed, a printing arrangement 20 for printing the pattern 44 onto the plastic sheet 14, and a moulding arrangement 22 for press moulding the plastic sheet into the mobile phone housing 25.

The plastic sheet 14 can be formed of any suitable plastics material, such as a thermoplastics material. Examples of such thermoplastics materials are polyethylene, polypropylene, polystyrene, acrylonitrile-butadiene-styrene, acrylic resin, polyamides, polycarbonates, polybutylene terephthalate, polyethylene terephthalate polyphenylene sulphide, thermoplastic polyurethane, derivatives of the above polymers.

The apparatus 10 also includes a first plating bath 24 for carrying out an electroless plating process on the plastic sheet, and a second plating bath 26 for carrying out an electroplating process on the article 25.

In operation, the plastic sheet 14 is obtained from a supply 12 and fed through via the feed roller 15 to a pair of pinch rollers 16, 18, and thereafter to a printing arrangement 20. The printing arrangement 20 comprises a cartridge 28 holding a carrier material in the form of an ink 29 which comprises a suspension of a seeding substance, in the form of plurality of metal particles. The amount of metal particles is in the range of 0.05 wt % to 5 wt % and the particles have an average diameter of no more than 0.15 μm. The seeding substance in the ink 29 is provided to seal the plating reactions which occur later in the method, and are described below.

The printing arrangement 20 also includes a plurality of roller members 30 through which these sheet 14 extends. The printing arrangement 20 prints the ink 29 onto the plastic sheet 14 in a desired line pattern, which will eventually form the electrical circuit line pattern 44 for the electronic components of the mobile phone.

The ink also includes a binder material for fixing the metallic material on the substrate.

The binder material can be a plastics material, which may be selected from the group consisting of acrylic resins, silicone, polyurethanes, polycarbonates, polyesters, rosins, rubbers, polyimides, polyolefins, derivatives of polyolefins, polystyrenes, derivatives of polystyrenes and polymer alloys such as acrylonitrile-butadiene-styrene, acrylstyrene. It is desirable that the binder material is capable of stretching or elongation to the same extent as the plastic sheet during the moulding process.

After the ink has been printed onto the plastic sheet 14, the plastic sheet 14 is then passed through the moulding arrangement 22 to undergo press moulding to form the housing 25 for the mobile phone. The housing 25 is thus formed from a pressed sheet which constitutes a substrate 42 for the pattern applied thereto. The housing 25 is in the form of a pressed sheet, which then undergoes at least one plating process, to plate the ink with a suitable metal to form the electrical circuit line pattern 44. The plating of the metal onto the ink may be a single stage electroplating step of an electroless plating step, or it may involve two stages, one stage being electroplating, and the other stage being electroless plating.

In the embodiment shown in FIG. 1, a two stage plating process is used. The first stage, is an electroless plating stage and the housing 25 is dipped into a suitable solution 30 in the electroless plating bath 24. During this stage, the metal particles constitute a catalyst to seed the electroless plating reaction. During the reaction, a metal is deposited from the electroless plating solution 30 onto the metal particle in the ink printed on the housing 25.

The second stage of the plating process is an electroplating stage. The housing 25 is arranged in a plating solution 32 in the electroplating bath 26 so that the plated metal from the electroless plating solution 26 is one of the electrodes and further metal is plated thereon.

In other embodiments, where only an electroplating stage is employed, then the metal particles in the ink are used as the appropriate electrode to seed the electrolytic plating reaction.

Referring to FIGS. 2 and 3, there is shown a moulded housing 25 for a mobile phone, which comprises the moulded substrate 42 formed from the plastic sheet as described above, and having printed thereon the electrical circuit line pattern 44 comprising a lower layer of the ink 46 and an upper layer of the plated metallic material 48. The pattern 44 forms the electrical connections for the electronic components of the mobile phone formed using the housing 25.

Various modifications can be made without departing from the scope of the invention. For example, the pattern could be different to that shown in FIG. 2.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of forming a pattern on an article comprising the steps of:
applying a carrier material to a substrate to provide the pattern, the carrier material carrying a seeding substance to allow application of a metallic material thereto;
moulding the substrate to form the article;
and applying the metallic material to the seeding substance on tie carrier material.

2. A method according to claim 1, wherein the carrier material is an ink and is applied to the substrate by printing.

3. A method according to claim 2, wherein the ink incorporates a binder material for fixing the sealing substance on the substrate.

4. A method according to claim 3, wherein the step of moulding the substrate can involve stretching some of the substrate, wherein the binder material is selected from materials capable of stretching to at least the same extent as the substrate.

5. A method according to claim 3, wherein the binder material is one or more selected from the group consisting of acrylic resins, silicone, polyurethanes, polycarbonates, polyesters, rosins, rubbers, polyimides, polyolefins, derivatives of polyolefins, polystyrenes, derivatives of polystyrenes and polymer alloys such as acrylonitrile-butadiene-styrene, acrylstyrene.

6. A method according to claim 1, wherein the seeding substance comprises a plurality of metal particles in the carrier material.

7. A method according to claim 6, wherein the step of applying the metallic material to the carrier material comprises plating the metallic material onto the metallic particles in the carrier material.

8. A method according to claim 7, wherein the step of plating the metallic material onto the carrier material comprises at least one step selected from the group consisting of electroplating and electroless plating.

9. A method according to claim 6, wherein the metal particles are present in a range of 0.005 wt % to 10 wt %.

10. A method according to claim 6, wherein the metal particles are present in a range of 0.05 wt % to 5 wt %.

11. A method according to claim 6, wherein the metal particles are present in a range of 0.1 wt % to 2 wt %.

12. A method according to claim 6, wherein the metal particles have an average size of no greater than 0.15 μm.

13. A method according to claim 6, wherein the metal particles have an average size in the range of 0.003 μm to 0.05 μm.

14. A method according to claim 6, wherein the metal particles have an average size in the range of 0.003 μm to 0.015 μm.

15. A method according to claim 1, wherein the step of moulding the substrate comprises press moulding the substrate to form the article.

16. A method according to claim 1, wherein the substrate comprises a plastic sheet.

17. A method according to claim 16 wherein the plastic sheet comprises a thermoplastic material.

18. A method according to claim 1, wherein the step of moulding the substrate is carried out before the step of applying the metallic material to the carrier material.

19. A method according to claim 1, wherein the pattern is a line pattern to define electrical connections.

20. A moulded article comprising a substrate and a pattern on the substrate, the pattern comprising a first layer of a carrier material, caring a seeding substrate, and a second layer of a metallic material, the second layer providing electrical connections.

21. A moulded article according to claim 20, wherein the carrier material is an ink.

22. A moulded article according to claim 21, wherein the ink incorporates a binder material for fixing the sealing substance on the substrate.

23. A moulded article according to claim 22, where the substrate is capable of stretching, the binder material is selected from materials capable of stretching to at least the same extent as the substrate.

24. A moulded article according to claim 22, wherein the binder material is one or more selected from the group consisting of acrylic resins, silicone, polyurethanes, polycarbonates, polyesters, rosins, rubbers, polyamides, polyolefins, derivatives of polyolefins, polystyrenes, derivatives of polystyrenes and polymer alloys such as acrylonitrile-butadiene-styrene, acrylstyrene.

25. A moulded article according to claim 20, wherein the seeding substance comprises a plurality of metal particles in the carrier material.

26. A moulded article according to claim 25, wherein the metallic material is a plating on the metallic particles in the carrier material.

27. A moulded article according to claim 26, wherein the plating of the metallic material on the carrier material comprises at least one selected from the group consisting of an electroplating and an electroless plating.

28. A moulded article according to claim 25, wherein the metal particles are present in the carrier a range of 0.005 wt % to 10 wt %.

29. A moulded article according to claim 25, wherein the metal particles are present in a range of 0.05 wt % to 5 wt %.

30. A moulded article according to claim 25, wherein the metal particles are present in a range of 0.1 wt % to 2 wt %.

31. A moulded article according to claim 21, wherein the metal particles have au average size of no greater than 0.15 μm.

32. A moulded article according to claim 25, wherein the metal particles have an average size in the range of 0.003 μm to 0.05 μm.

33. A moulded article according to claim 25, wherein the metal particles have an average size in the range of 0.003 μm to 0.015 μm.

34. A moulded article according to claim 20, wherein the substrate comprises a plastic sheet.

35. A moulded article according to claim 34 wherein the plastic sheet comprises a thermoplastic material.

36. A moulded article according to claim 20, wherein the pattern is a line pattern.

37. Apparatus for forming a pattern on an article comprising a supply assembly for supplying a substrate, a first applicator for applying a carrier material to the substrate, the carrier material carrying a seeding substance to allow application of a metallic material thereto, a moulding arrangement for moulding the substrate to form the article, and a second applicator for applying the metallic material to the seeding substance on the carrier material.

38. Apparatus according to claim 37, wherein the first applicator is a printer and the carrier material is an ink.

39. Apparatus according to claim 37, wherein the second applicator is a plating assembly for plating the metallic material onto the seeding substance.

40. Apparatus according to claim 39, wherein the plating assembly is at least one selected from the group consisting of an electroplating assembly and an electroless plating assembly.

41. Apparatus according to claim 37, wherein the moulding arrangement comprises a press moulding arrangement.
